(19) United States
(12) Patent Application Publication
(10) Pub. No.: US 2019/0375362 A1
(43) Pub. Date: Dec. 12, 2019

(54) GAS BAG ARRANGEMENT FOR A VEHICLE OCCUPANT RESTRAINT SYSTEM OF A MOTOR VEHICLE

(71) Applicant: Joyson Safety Systems Germany GmbH, Aschaffenbrg (DE)

(72) Inventors: Torsten Steiner, Berlin (DE); Volker Rathgeb, Allmendingen (DE); Karl-Heinz Buhrlen, Ulm-Donaustetten (DE); Thomas Reichenbecher, Ulm (DE)

(73) Assignee: Joyson Safety Systems Germany GmbH, Aschaffenburg (DE)

(21) Appl. No.: 16/433,936

(22) Filed: Jun. 6, 2019

(30) Foreign Application Priority Data
Jun. 6, 2018 (DE) 10 2018 208 94108

(51) Int. Cl. B60R 21/207; B60R 21/231

(52) U.S. Cl. CPC B60R 21/207; B60R 2021/0058; B60R 21/23138

(57) ABSTRACT

A gas bag arrangement for a vehicle occupant restraint system of a motor vehicle comprises an inflatable gas bag which includes at least one first inflatable chamber configured to protect the head of a vehicle occupant and at least one second inflatable chamber configured to protect a shoulder and/or thorax region of the vehicle occupant, wherein the gas bag is to be arranged in or on a side of a vehicle seat facing the vehicle interior space; and at least one connecting element connected to the gas bag for connecting the gas bag to the vehicle seat or to another component of the vehicle. The connecting element is connected to the gas bag such that a partial section of the connecting element extends on a side of the gas bag which in the folded and/or inflated condition of the gas bag faces away from a vehicle occupant.

### REFERENCE TO RELATED APPLICATION

This application claims priority to German Patent Application No. 10 2018 208 941.8 filed on Jun. 6, 2018, the entirety of which is incorporated by reference herein.

### BACKGROUND

This disclosure relates to a gas bag arrangement for a vehicle occupant restraint system of a motor vehicle.

The gas bags (“far-side” gas bags) of such gas bag arrangements in particular serve to protect a vehicle occupant in a collision on the vehicle long side more remote from the vehicle occupant to be protected (i.e. in a “far-side crash”). For example, DE 10 2012 216 896 A1 discloses such a far-side gas bag. In the known far-side gas bags, however, a relative movement can occur between the vehicle occupant and the gas bag, whereby the restraining effect of the gas bag can be impaired and injuries of the vehicle occupant can be caused.

### SUMMARY

The problem underlying the proposed solution consists in coupling the vehicle occupant to the gas bag as early as possible and as completely as possible.

This problem is solved by the provision of the gas bag arrangement with features as described herein.

Accordingly, there is provided a gas bag arrangement for a vehicle occupant restraint system of a motor vehicle, comprising
an inflatable gas bag which includes at least one first inflatable chamber configured to protect the head of a vehicle occupant and at least one second inflatable chamber configured to protect a shoulder and/or thorax region of the vehicle occupant,
wherein the gas bag is to be arranged in or on a side of a vehicle seat facing the vehicle interior space;
at least one connecting element connected to the gas bag for connecting the gas bag to the vehicle seat or to another component of the vehicle, wherein
the connecting element is connected to the gas bag such that a partial section of the connecting element extends on a side of the gas bag which in the folded and/or inflated condition of the gas bag faces away from a vehicle occupant sitting on the vehicle seat (in particular on a side of the gas bag which faces away from the vehicle seat as seen in the vehicle transverse direction).

This course of the connecting element in particular provides for a stabilization and/or positioning of the inflated gas bag relative to the vehicle occupant to be protected such that a coupling of the vehicle occupant to the gas bag is effected as early as possible and thus a movement in particular of the upper body region of the vehicle occupant relative to the gas bag is counteracted. The connecting element in particular is a catch strap or a bracing veil. The connecting element may be formed from a woven fabric.

The connecting element can extend and be connected to the gas bag such that during the inflation of the gas bag the first chamber at least sectionally moves towards a vehicle occupant sitting on the vehicle seat and/or moves relative to the second chamber. In particular, the first chamber at least sectionally moves relative to the second chamber towards the vehicle occupant, whereby the above-mentioned coupling of the upper body region of the vehicle occupant, in particular of his head, to the gas bag can be realized as early as possible.

It is also conceivable that the connecting element extends and is connected to the gas bag such that the extension (height) of the gas bag in the vehicle height direction is reduced (as compared to the extension without connecting element). A bracing path assigned to the connecting element may be shortened. The reduction of the gas bag extension in the vehicle height direction may be obtained by the above-mentioned movement of the first chamber towards the vehicle occupant. It is also conceivable that during the inflation of the gas bag an at least partial curvature or rotation of the first chamber is effected in the direction of the vehicle occupant and hence the reduction of the height extension of the gas bag occurs.

According to another variant of the solution the partial section of the connecting element extends on a side of the first and/or the second chamber facing away from the vehicle occupant sitting on the vehicle seat. It is conceivable that the connecting element extends and is connected to the first and/or the second chamber such that during the inflation of the gas bag a rotation or torsion at least of a portion of the first and/or the second chamber is obtained. The rotation or torsion may be effected about an axis following the direction of extension of the chamber.

It is also possible that the partial section of the connecting element extends on a side of the second chamber facing away from the vehicle occupant, wherein a further partial section of the connecting element extends on a side of the first chamber facing the vehicle occupant. A partial area of the connecting element between these two partial sections may be coupled with an area of the vehicle seat (in particular a frame of a backrest of the vehicle seat); in particular such that at the area of the vehicle seat a deflection of the connecting element is effected.

In the inflated condition of the gas bag the first chamber at least partly may extend above the second chamber (as seen in the vehicle height direction).

According to another development, the connecting element extends through between the first and the second chamber The connecting element coming from a connecting area of the vehicle seat may extend through between the first and the second chamber to the outside (i.e. to the side facing away from the vehicle occupant) of the first chamber (and may be connected there to the first chamber).

In addition, it is conceivable that in the inflated condition the first and/or the second chamber extend arcuately, wherein the two chambers can each be of tubular design and may be arranged one above the other as seen in the vehicle height direction. The first and/or the second chamber may extend semi-annularly (for example in the manner of half a donut), wherein a curvature of the first and/or the second chamber is oriented upwards as seen in the vehicle height direction. It is also conceivable that at least the second chamber is of annular design (for example in the manner of a whole donut).

By means of the connecting element a portion of the gas bag (e.g. of the first or second chamber) and a portion of the second chamber can also be connected to each other.

Furthermore, the first and the second chamber of the gas bag can be connected to each other at least in a front region (i.e. in a region pointing towards the vehicle front) of the gas bag; for example via a connecting seam. This connection between the two chambers in particular is configured such that in the inflated condition of the gas bag an overlap as good as possible or at least a spacing as small as possible is formed between the chambers. It is of course also possible that the two chambers are connected to each other not only in the front region of the gas bag, but at least one further connecting point exists in another (for example rear) region of the gas bag. However, there can also be provided a region of the gas bag in which the two chambers are not connected to each other, wherein in this region the connecting element may extend through between the chambers.

According to another embodiment the connecting element (configured e.g. in the form of a bracing veil) comprises a loop which in the folded condition of the gas bag surrounds a portion of the second chamber, wherein during the inflation of the second chamber the loop moves relative to the portion and acts on the same such that it at least partly rotates towards a vehicle occupant sitting on the vehicle seat.

In particular, during the inflation of the gas bag the loop slides along the second chamber and in doing so exerts a force (a torque) on the second chamber which generates the rotation of the second chamber towards the vehicle occupant.

Under the influence of the loop the second chamber may rotate about an axis oriented at least approximately parallel to a direction of movement of the loop, for example aligned at least approximately along the vehicle longitudinal direction.

It is also possible that in the fully inflated condition of the gas bag, i.e. at the end of its movement relative to the second chamber, the loop is disposed in a front partial section of the second chamber (and surrounds the second partial section). It is conceivable that slipping of the loop from the second chamber is counteracted in that the diameter of the second chamber increases towards the front side of the second chamber and forms at least one portion whose diameter is greater than the inside diameter of the loop.

The proposed solution also relates to a vehicle seat with the gas bag arrangement as described herein.

The connecting element may directly or indirectly coupled, e.g. fixed, to a portion of a frame of a backrest of the vehicle seat. The connecting element may be fixed to a holding element connected to the frame of the backrest of the vehicle seat, wherein the connecting element may be deflected at the holding element. It is conceivable here that the connecting element coming from the outside of the second chamber is deflected at the holding element in the direction of an inside of the first chamber so that as already mentioned above a first partial section of the connecting element extends on the outside of the second chamber and a second partial section extends on the inside of the first chamber.

The holding element in particular is positively connected to the frame of the vehicle seat and has at least one protrusion (finger) to which a portion of the connecting element is fixed (for example via an opening or loop).

### BRIEF DESCRIPTION OF THE DRAWINGS

The solution will be explained in detail below by means of embodiments with reference to the Figures.

FIG. 1 schematically shows a gas bag arrangement according to an embodiment arranged on a vehicle seat after the inflation of the gas bag.

FIG. 2 shows the gas bag arrangement of FIG. 1, wherein the gas bag is shown in a section along line A-A in FIG. 1 and in a condition spread out, but not fully inflated.

FIG. 3 shows the gas bag of FIG. 2 in the inflated condition.

FIG. 4 shows a gas bag arrangement arranged at the vehicle seat according to a second embodiment after the inflation of the gas bag.

FIG. 5 shows the gas bag arrangement of FIG. 4, wherein the gas bag is shown in a section along line B-B in FIG. 4 and in a condition spread out, but not fully inflated.

FIG. 6 shows the gas bag of FIG. 5 in the inflated condition.

FIG. 7 shows a gas bag arrangement according to a third embodiment, wherein the gas bag is shown in a section (along a line extending analogous to the line B-B in FIG. 4) and in a condition spread out, but not fully inflated.

FIG. 8 shows the gas bag of FIG. 7 in the inflated condition.

FIG. 9 shows an enlarged section of FIG. 8 in the region of the holding element.

FIG. 10 shows a gas bag arrangement according to a fourth embodiment, wherein the gas bag is shown in a section (along a line extending analogous to the line B-B in FIG. 4) and in a condition spread out, but not fully inflated.

FIG. 11 shows the gas bag of FIG. 10 in the inflated condition.

FIG. 12 shows a gas bag arrangement according to a fifth embodiment, wherein the gas bag is shown in a section (along a line extending analogous to the line B-B in FIG. 4) and in a condition spread out, but not fully inflated.

FIG. 13 shows the gas bag of FIG. 12 in the inflated condition.

FIG. 14 shows an enlarged section of gas bag arrangement in the region of the holding element.

FIG. 15 shows a modification of FIG. 14.

FIG. 16 shows a gas bag arrangement according to a sixth embodiment in a side view.

FIG. 17 shows a portion of the second chamber of the gas bag of the gas bag arrangement of FIG. 16 during the inflation of the gas bag.

FIG. 18 shows a section through the gas bag arrangement of FIG. 16 along line B-B in

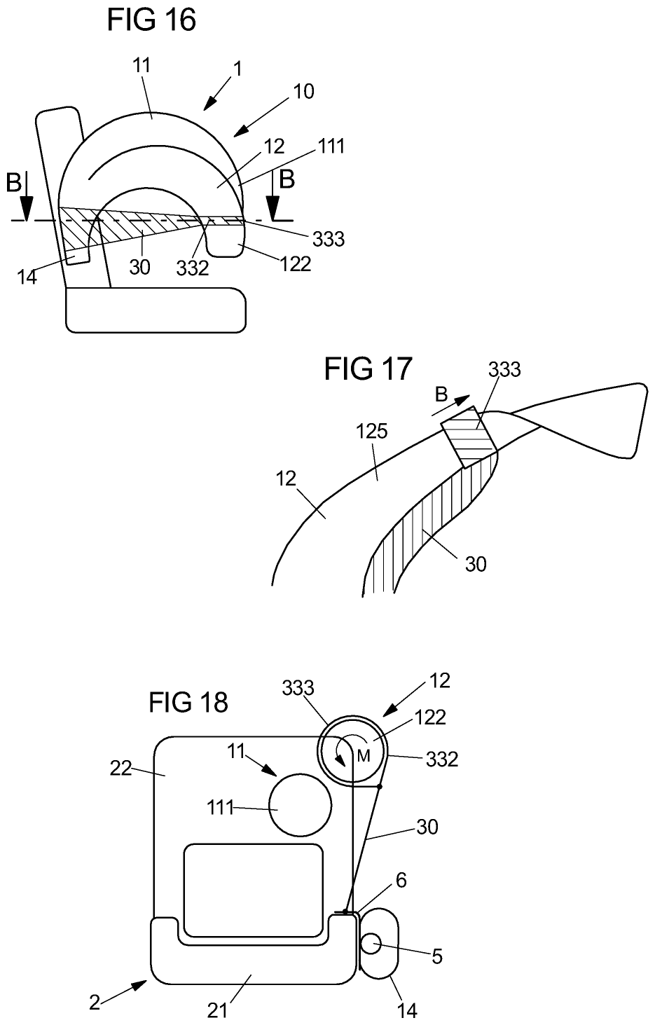

FIG. 16.

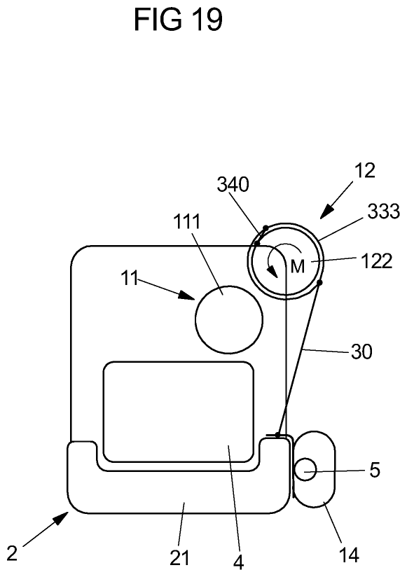

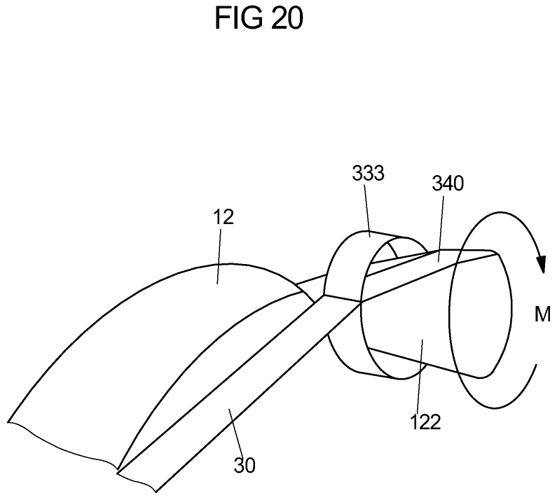

FIG. 19 shows a modification of FIG. 18.

FIG. 20 shows a perspective view of the torso chamber and the bracing veil of FIG. 19.

### DETAILED DESCRIPTION

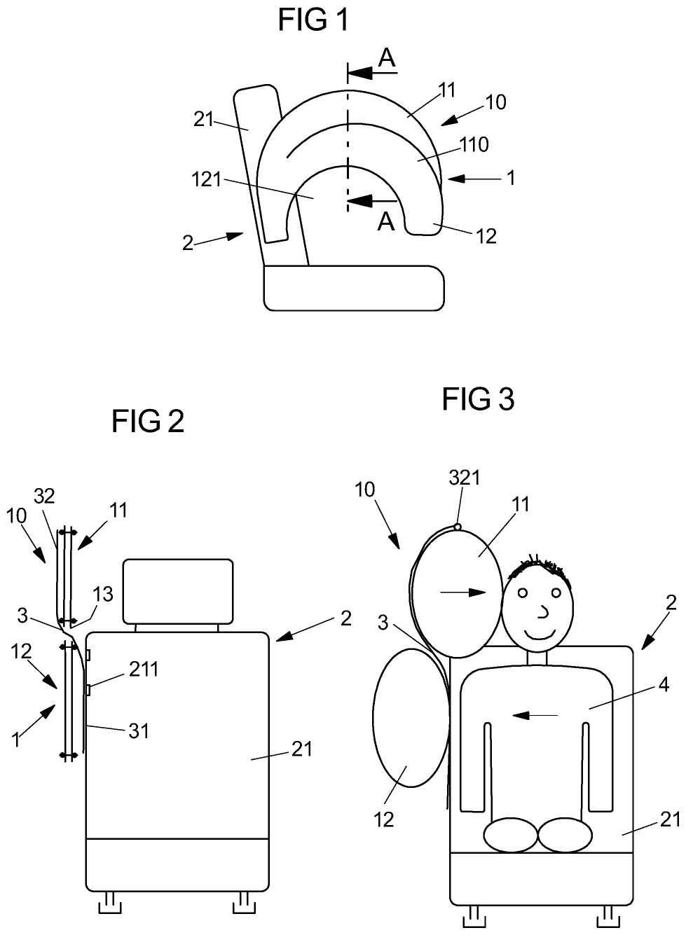

The gas bag arrangement 10 according to the proposed solution as shown in FIG. 1 comprises a gas bag 1 arranged at a vehicle seat 2. The gas bag 1 in turn includes a first inflatable chamber in the form of a head chamber 11 and a second chamber in the form of a torso chamber 12, which is at least partly arranged below the head chamber 11. In the inflated condition of the gas bag 1 as shown in FIG. 1, the chambers 11, 12 at least partly extend arcuately and in particular each in tubularly, wherein at least in a middle or front region as seen along the vehicle longitudinal direction the head chamber 11 is disposed closer to the vehicle occupant to be protected (not shown in FIG. 1; cf. FIG. 3) than the torso chamber 12.

Due to its arc-shaped configuration (in the manner of half a donut), the torso chamber 12 has an upwardly pointing curvature and correspondingly delimits a semicircular opening 121 disposed below the curvature. The opening 121 in particular is placed such that during an impact of the vehicle occupant onto the gas bag 1 an arm portion and/or a shoulder of the vehicle occupant will at least partly move into the opening 121. In this way it can be prevented for example that the arm or the shoulder of the vehicle occupant pushes the gas bag 1 away and thus counteracts a coupling of the vehicle occupant to the gas bag 1. It is conceivable that in the inflated condition the head chamber 11 has a larger thickness (measured in the vehicle transverse direction) than the torso chamber 12. In addition, it is possible that the torso chamber 12 is of ring-shaped design and completely encloses the opening 121 (i.e. the torso chamber 12 has the shape of a whole donut). The head chamber 11 can also be connected to the thorax chamber 12 in a front region 110 of the gas bag 1 (for example via at least one seam). It is also conceivable that the torso chamber 12 does not form a closed ring, but a spacing exists between the end portions of the (annularly curved) torso chamber 12. For example, a front and/or rear end portion of the torso chamber 12 is fixed to a backrest 21 of the vehicle seat 2 via a catch strap in order to close the torso chamber 12.

The gas bag arrangement 10 furthermore comprises a connecting element in the form of a catch strap 3; cf. FIGS. 2 and 3. The catch strap 3 is fixed to a frame 211 of the backrest 21 of the vehicle seat 2 with a first partial section 31 and extends from the fastening point at the frame 211 through a spacing 13 between the head chamber 11 and the torso chamber 12. The catch strap 3 can also be fixed to a holding element (in particular in the manner of the holding element 6 of FIG. 5) connected to the frame 211. It is noted that FIG. 2 other than FIG. 1 shows the gas bag 1 spread out flat, but not fully inflated. The condition of the gas bag 1 shown in FIG. 2 primarily serves for a better understanding of the gas bag structure and of the course of the catch strap 3 and does not necessarily correspond to a real condition of the gas bag 1. It is also conceivable, however, that after exiting from a module housing (not shown) and/or the backrest 21, the gas bag 1 assumes the condition shown in FIG. 2 or at least a similar condition.

After traversing the spacing 13, the catch strap 3 extends with a second partial section 32 on a side (outside) of the head chamber 11 facing away from the vehicle seat 2, wherein a portion of the catch strap 3 is connected to the head chamber 11 (for example via a seam 321). The second partial section 32 in particular extends and is connected to the head chamber 11 such that during the inflation of the gas bag 1 the head chamber 11 moves relative to the torso chamber 12 towards the vehicle occupant 4 sitting on the vehicle seat 2 (in particular towards the head of the vehicle occupant 4), cf. FIG. 3. It is also conceivable that a front portion of the inflated head chamber 11 is disposed in front of a shoulder region of the vehicle occupant 4 and fixes the same.

For example, the chambers 11, 12 take such a position relative to each other that the gas bag 1 engages around a portion of the head and upper body region of the vehicle occupant 4 (for example in the manner of a baseball glove) and thus counteracts slipping of the vehicle occupant 4 from the gas bag 1.

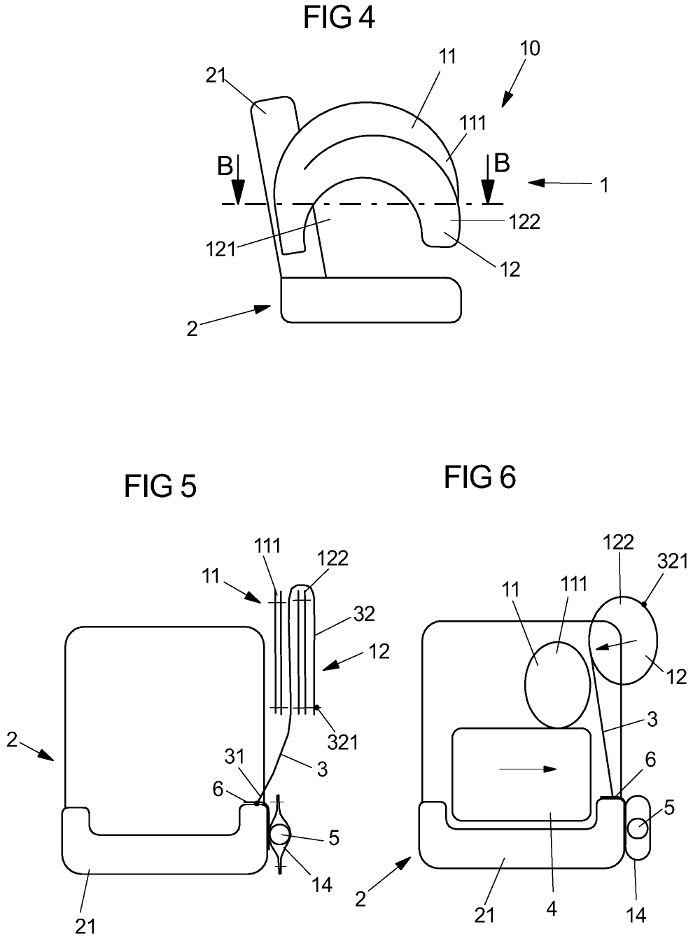

FIGS. 4 to 6 relate to a further embodiment of the gas bag arrangement 10, wherein the gas bag 1 can be designed analogous to FIG. 1. The gas bag arrangement 10 in turn includes a connecting element in the form of a catch strap 3, which with a first partial section 31 in turn is attached to a frame 211 of the backrest 21 of the vehicle seat 2; cf. FIGS. 5 and 6 (the catch strap 3 is not shown in FIG. 4). In the front region of the gas bag 1 a second partial section 32 of the catch strap 3 extends around a front portion 122 of the torso chamber 12 and then extends along an outside of the torso chamber 12. Finally, the portion 32 of the catch strap 3 is fixed to the torso chamber 12 via a seam 321.

By means of the catch strap 3 a positioning of the gas bag 1 is effected during the inflation such that the front region 122 in the torso chamber 12 and also a front region 111 of the head chamber 11 move in the direction of the vehicle occupant 4. In particular, both portions engage a head/shoulder region of the vehicle occupant 4, wherein after the inflation of the gas bag 1 at least the front region 111 of the head chamber 11 can be disposed for example in front of the shoulder region of the vehicle occupant 4 (the head chamber 11 hence does not only serve to protect the head of the vehicle occupant 4, but also to fix the shoulder of the vehicle occupant).

It is also noted that in addition to the catch strap shown in FIGS. 5 and 6 a catch strap in the manner of the embodiment of FIGS. 2 and 3 can be present. The connection of the catch strap in particular is effected via a holding element 6 in the form of a bracket which is positively connected to the frame 211 of the backrest 21. As already mentioned above, the holding element 6 can include protrusions via which the catch strap 3 is connected to the holding element 6 and hence to the backrest 21. For example, the catch strap 3 is hooked into the protrusions of the holding element 6. In a rear region 14 of the gas bag 1 a gas generator 5 for inflating the gas bag 1 is disposed.

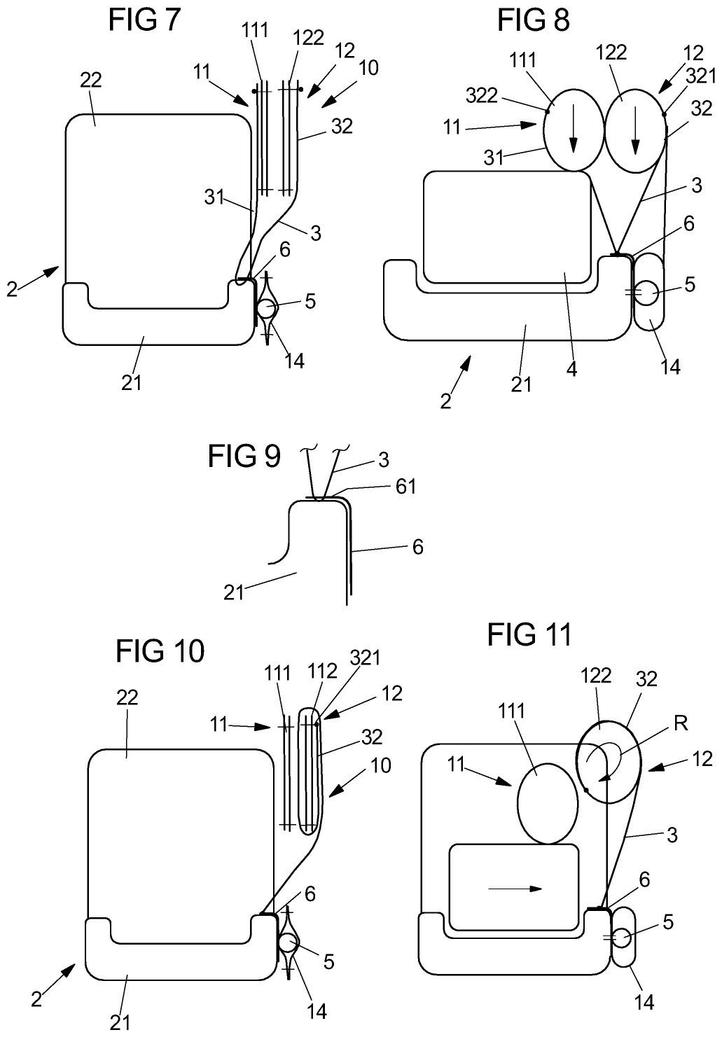

FIGS. 7 to 9 relate to another variant of the solution. Accordingly, a deflection of the catch strap 3 is effected at the holding element 6 such that a first partial section 31 of the catch strap 3 extends on an inside of the front portion 111 of the head chamber 11 which faces the vehicle occupant 4 sitting on a seating surface 22 of the vehicle seat 2, and a second portion 32 of the catch strap 3 extends on a side of the front portion 122 of the torso chamber 12 which faces away from the vehicle occupant 4. In particular, the portions 31, 32 are fixed to the chamber portions 111, 122 via seams 321, 322. Due to the inflation of the gas bag 1, a movement (in particular in the vehicle transverse direction and/or in the vehicle longitudinal direction) at least of the front portions 111, 122 of the head chamber 11 and the torso chamber 12 towards the vehicle occupant 4 in turn occurs.

FIG. 9 shows the connection of the catch strap 3 to the holding element 6 on an enlarged scale. Accordingly, the catch strap 3 couples with a portion 61 of the holding element 6 pointing in the direction of forward travel such that the above-mentioned deflection of the catch strap 3 is effected. For example, the catch strap 3 extends around a portion (for example a protrusion) of the holding element 6.

According to the embodiment illustrated in FIGS. 10 and 11, the catch strap 3 coming from the holding element 6 initially extends along an outside of the front portion 122 of the torso chamber 12 and is wound around the front portion 122. Finally, an end portion 32 of the catch strap 3 is fixed to the portion 122 of the torso chamber 12 via a seam 321. During the inflation of the gas bag 1 the winding of the catch strap 3 is dissolved and a rotation or torsion (for example seen from above in the clockwise direction about an axis of rotation R at least approximately oriented in the vehicle height direction) of the portion 122 of the torso chamber 12 is obtained. This rotation or torsion of the portion 122 of the torso chamber 12 in turn can effect a movement of this portion of the torso chamber 12 towards the vehicle occupant 4.

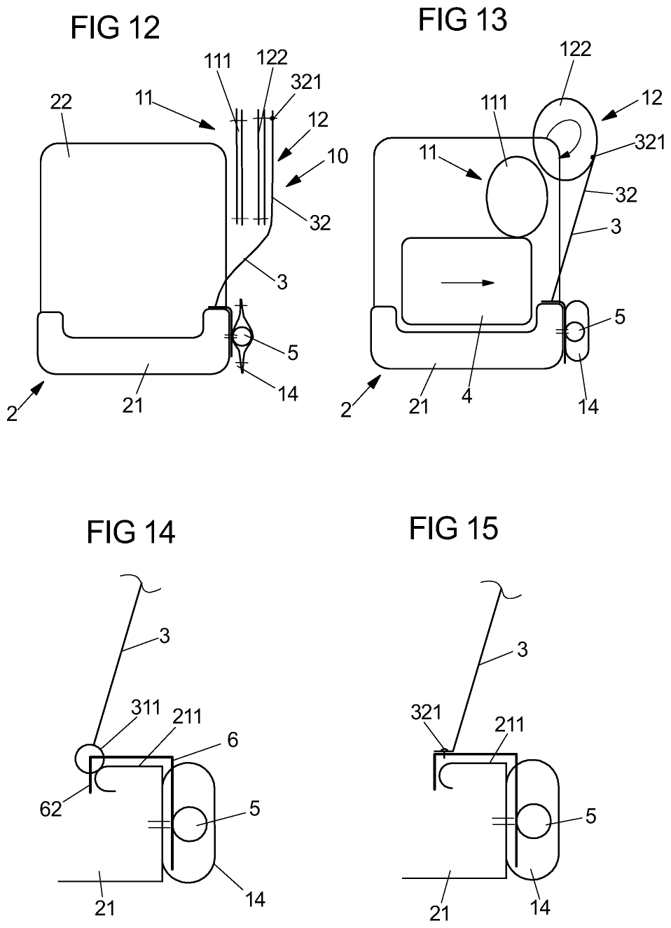

A modification of FIGS. 10 and 11 is shown in FIGS. 12 and 13. Accordingly, the front portion 32 of the catch strap 3 is not wound around the front portion 122 of the torso chamber 12, but merely extends along the outside of the portion 122 and is connected to the torso chamber 12 in a front region of the portion 122 (analogous to FIGS. 10 and 11 via a seam 321). In this variant, too, a rotation or torsion of the front portion 122 of the torso chamber 12 about the axis R occurs upon deployment of the gas bag 1.

It is noted that analogous to FIGS. 10 to 13 a catch strap alternatively or in addition can also be connected to the front portion 111 of the head chamber 11 (for example be wound around the portion 111) such that a rotation or torsion (for example seen from above in counterclockwise direction) of the portion 111 of the head chamber 11 is generated. It is also conceivable that alternatively or in addition a catch strap is provided, which puts another portion of the head or thorax chamber 11, 12 into rotation or torsion.

FIGS. 14 and 15 show further possibilities of the connection of the catch strap 3 to the holding element 6. Accordingly, the holding element 6 has at least one finger 62 engaging around the frame 211 of the backrest 21 of the vehicle seat 2, into which a loop 311 or an opening of the catch strap 3 is hooked (FIG. 14). For example, two fingers 62 engage into corresponding loops or openings of the catch strap 3. It is also possible, however, that the fingers 62 are omitted and the catch strap 3 is connected to the holding element 6 in another way.

For example, the catch strap 3 is attached to the holding element 6 by means of a fastening element (for example a rivet 312) (FIG. 15). It is conceivable that the catch strap 3 is overturned in the region of the fastening element (for example 90°). It is possible that the catch strap is fixed to the holding element as far in as possible, i.e. as far as possible towards the middle of the vehicle seat (as seen in the vehicle transverse direction) in order to produce a retaining force or bracing force as large as possible, which braces the gas bag towards the inside. However, the exact configuration of the holding element 6 and of the attachment of the catch strap 3 to the holding element 6 in particular depends on the geometry of the backrest 21 and in particular of the frame 211.

FIGS. 17 to 20 relate to another embodiment. Accordingly, in the inflated condition of the gas bag 1 a connecting element in the form of a bracing veil 30 extends from the rear region 14 of the gas bag 1 or a rear portion of the torso chamber 12 in the vehicle longitudinal direction to the front portion 122 of the torso chamber 12. A front portion 332 of the bracing veil 30 forms a loop 333 which surrounds the front portion 122 of the torso chamber 12.

Before the inflation of the gas bag 1 the loop 333 initially loosely surrounds the torso chamber 12, wherein at least a middle and/or front portion 125 of the torso chamber 12, for example the portion 122, is twisted towards the outside. During the deployment of the gas bag 1 the loop 333 moves along a direction of movement B across the twisted portion 125 of the torso chamber 12 and in doing so exerts a torque M on this portion 125 of the torso chamber 12, which rotates the same to the inside, i.e. towards the vehicle occupant, in order to effect an approach to the vehicle occupant; cf. FIGS. 17 and 18. Slipping of the loop 333 from the torso chamber 12 can be avoided for example by the configuration of the front portion 122 of the torso chamber 12. For example, the diameter of the torso chamber 12 correspondingly increases towards the front.

It is also conceivable that the loop 333 is connected to the gas bag 1 by means of a further connecting element 340 (for example in the form of a catch strap) in order to support the generation of the torque M. In particular, the connecting element 340 is connected to the front portion 122 of the torso chamber 12; cf. FIGS. 19 and 20. Due to the connection of the loop 333 with the gas bag 1, in particular with the torso chamber 12 (for example with the front portion 122 of the torso chamber 12) via the connecting element 340, a rotation of the front portion 122 of the torso chamber 12 in the direction of the torque M results in the bracing veil 30 being partly wound up in this direction. The bracing veil 30 thereby is shortened, whereby for example a specifiable positioning at least of the front portion 122 of the torso chamber 12 is effected. In addition, it is noted that instead of a bracing veil a catch strap might also be used. Furthermore, the bracing veil can also be designed such that the loop 333 does not move across the torso chamber 12, but across the head chamber 11 in order to generate a rotation or torsion of the head chamber 11. It is also conceivable that the loop 333 is drawn both over the torso chamber 12 and over the head chamber 11 and during the inflation of the gas bag 1 correspondingly causes a rotation or torsion both of the torso chamber and of the head chamber.

In addition, it is noted that elements of the embodiments described above can of course also be used in combination with each other. For example the gas generator 5 shown in FIG. 5 can analogously be present and positioned also in the embodiment of FIGS. 1 to 3. What is also possible in particular is a combination of the bracing veil 30 of FIGS. 16 to 19 with the catch strap 3 of the embodiments of FIGS. 1 to 13. In addition, the gas bag arrangement according to the proposed solution might also be accommodated in a center console of the vehicle.

1. A gas bag arrangement for a vehicle occupant restraint system of a motor vehicle, comprising
an inflatable gas bag which includes at least one first inflatable chamber configured to protect the head of a vehicle occupant and at least one second inflatable chamber configured to protect a shoulder and/or thorax region of the vehicle occupant,
wherein the gas bag is to be arranged in or on a side of a vehicle seat facing the vehicle interior space; and
at least one connecting element connected to the gas bag for connecting the gas bag to the vehicle seat or to another component of the vehicle,
wherein the connecting element is connected to the gas bag such that a partial section of the connecting element extends on a side of the gas bag which in the folded and/or inflated condition of the gas bag faces away from a vehicle occupant sitting on the vehicle seat.

2. The gas bag arrangement according to claim 1, wherein the connecting element extends and is connected to the gas bag such that during the inflation of the gas bag the first chamber at least sectionally moves towards the vehicle occupant and/or relative to the second chamber.

3. The gas bag arrangement according to claim 1, wherein the connecting element extends and is connected to the gas bag such that the extension of the gas bag in the vehicle height direction is reduced.

4. The gas bag arrangement according to claim 1, wherein the partial section of the connecting element extends on a side of the first and/or the second chamber facing away from the vehicle occupant.

5. The gas bag arrangement according to claim 1, wherein the partial section of the connecting element extends on a side of the second chamber facing away from the vehicle occupant, wherein a further partial section of the connecting element extends on a side of the first chamber facing the vehicle occupant.

6. The gas bag arrangement according to claim 1, wherein the connecting element extends through between the first and the second chamber.

7. The gas bag arrangement according to claim 1, wherein in the inflated condition the first and/or the second chamber extends arcuately.

8. The gas bag arrangement according to claim 1, wherein the first and the second chamber are connected to each other at least in a front region of the gas bag.

9. The gas bag arrangement according to claim 1, wherein a portion of the gas bag and a portion of the second chamber are connected to each other via the connecting element.

10. The gas bag arrangement according to claim 1, wherein the connecting element comprises a loop which surrounds a portion of the second chamber, wherein during the inflation of the second chamber the loop moves relative to the portion and in doing so acts on the same such that it at least partly rotates towards the vehicle occupant.

11. The gas bag arrangement according to claim 10, wherein under the influence of the loop the second chamber rotates about an axis oriented at least approximately parallel to a direction of movement of the loop.

12. The gas bag arrangement according to claim 10, wherein in the fully inflated condition of the gas bag the loop is disposed in a front partial section of the second chamber.

13. A vehicle seat with a gas bag arrangement according to claim 1.

14. The vehicle seat according to claim 13, wherein the connecting element is directly or indirectly coupled with a portion of a frame of a backrest of the vehicle seat.

15. The vehicle seat according to claim 14, wherein the connecting element is fixed to a holding element connected to the frame of the backrest of the vehicle seat.

16. The vehicle seat according to claim 14, wherein the partial section of the connecting element extends on a side of the second chamber facing away from the vehicle occupant, wherein a further partial section of the connecting element extends on a side of the first chamber facing the vehicle occupant, wherein the connecting element is deflected at the holding element connected to the frame of the backrest of the vehicle seat.
